(19) United States
(12) Patent Application Publication
(10) Pub. No.: US 2014/0202289 A1
(43) Pub. Date: Jul. 24, 2014

(54) FLEXIBLE TOOL ROD DEVICE

(71) Applicant: Chin-Tan Huang, Taichung City (TW)

(72) Inventor: Chin-Tan Huang, Taichung City (TW)

(21) Appl. No.: 13/932,124

(22) Filed: Jul. 1, 2013

(30) Foreign Application Priority Data
Jan. 23, 2013 (TW) 102201489

(51) Int. Cl. B25B 23/00

(52) U.S. Cl. CPC B25B 23/0021
USPC 81/177.6

(57) ABSTRACT

A flexible tool rod device includes an inner rod unit and a sleeve pipe unit. The inner rod unit includes a drive head, a tool head opposite to the drive head, and a flexible connecting member interconnecting the drive and tool heads. The sleeve pipe unit is made of rigid material and includes a first sleeve pipe and a second sleeve pipe. The first sleeve pipe has a first end portion connected fixedly to one of the drive and tool heads. The second sleeve pipe is telescopically connected to the first sleeve pipe, and is movable relative to the first sleeve pipe between a covered position for providing rigidity to the flexible tool rod device, and an uncovered position to allow resilient deformation of the connecting member.

### CROSS-REFERENCE TO RELATED APPLICATIONS

This application claims priority of Taiwanese Patent Application No. 102201489, filed on Jan. 23, 2013.

### BACKGROUND OF THE INVENTION

1. Field of the Invention

This invention relates to a flexible tool rod device, more particularly to a flexible tool rod device including a sleeve pipe unit that is operable for enhancing rigidity of the tool rod device.

2. Description of the Related Art

A conventional flexible tool rod device 10 is suitable for special environmental conditions that are difficult to reach, such as in slots, corners and slits. Referring to FIG. 1, the conventional flexible tool rod device 10 includes a drive head 11, a tool head 12 opposite to the drive head 11, and a flexible connecting member 13 interconnecting the drive and tool heads 11, 12. The drive head 11 is connected to an extension rod 111 that is driven rotatably by a power source, such as a motor. The tool head 12 is connected to a holder 121 for holding, for example, a drive bit. The flexible connecting member 13 includes a central cable 131 and a bellows tube 132 sleeved on the central cable 131. Although the flexible connecting member 13 enables the conventional flexible tool rod device 10 to be freely bent in various directions, the rigidity of the flexible connecting member 13 is insufficient so that transmission of kinetic force from the power source to the drive bit is unstable.

### SUMMARY OF THE INVENTION

Therefore, an object of the present invention is to provide a flexible rod device that can overcome the aforesaid drawbacks of the prior art.

Accordingly, a flexible tool rod device of this invention includes an inner rod unit and a sleeve pipe unit. The inner rod unit includes a drive head, a tool head opposite to the drive head, and a flexible connecting member interconnecting the drive and tool heads. The sleeve pipe unit is made of a rigid material and includes a first sleeve pipe and a second sleeve pipe. The first sleeve pipe has a first end portion connected fixedly to one of the drive and tool heads. The second sleeve pipe is telescopically connected to the first sleeve pipe and movable relative to the first sleeve pipe between a covered position, where the second sleeve pipe is connected to the other one of the drive and tool heads and cooperates with the first sleeve pipe to be sleeved on the connecting member for providing rigidity to the flexible tool rod device, and an uncovered position, where the second sleeve pipe is separated from the other one of the drive and tool heads to expose a portion of the connecting member so as to allow resilient deformation of the connecting member.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary sectional view of a conventional flexible tool rod device;

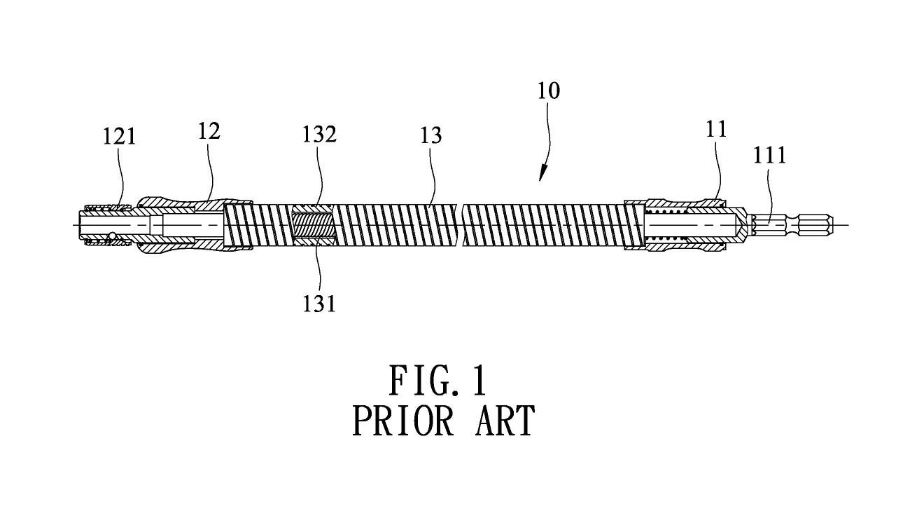

FIG. 2 is a sectional view of the first preferred embodiment of a flexible tool rod device according to this invention, illustrating a second sleeve pipe unit at a covered position;

FIG. 3 is an enlarged fragmentary sectional view of a section labeled “I” in FIG. 2;

FIG. 4 is another sectional view of the first preferred embodiment, illustrating the second sleeve pipe unit at an uncovered position;

FIG. 5 is another enlarged fragmentary sectional view of a section labeled “II” in FIG. 4;

FIG. 6 is a fragmentary sectional view of the second preferred embodiment of the flexible tool rod device according to this invention, illustrating the second sleeve pipe unit at the covered position;

FIG. 7 is another fragmentary sectional view of the second preferred embodiment, illustrating the second sleeve pipe unit at the uncovered position; and

FIG. 8 is a fragmentary sectional view of the third preferred embodiment of the flexible tool rod device according to this invention.

### DETAILED DESCRIPTION OF THE PREFERRED EMBODIMENTS

Before the present invention is described in greater detail, it should be noted that like elements are denoted by the same reference numerals throughout the disclosure.

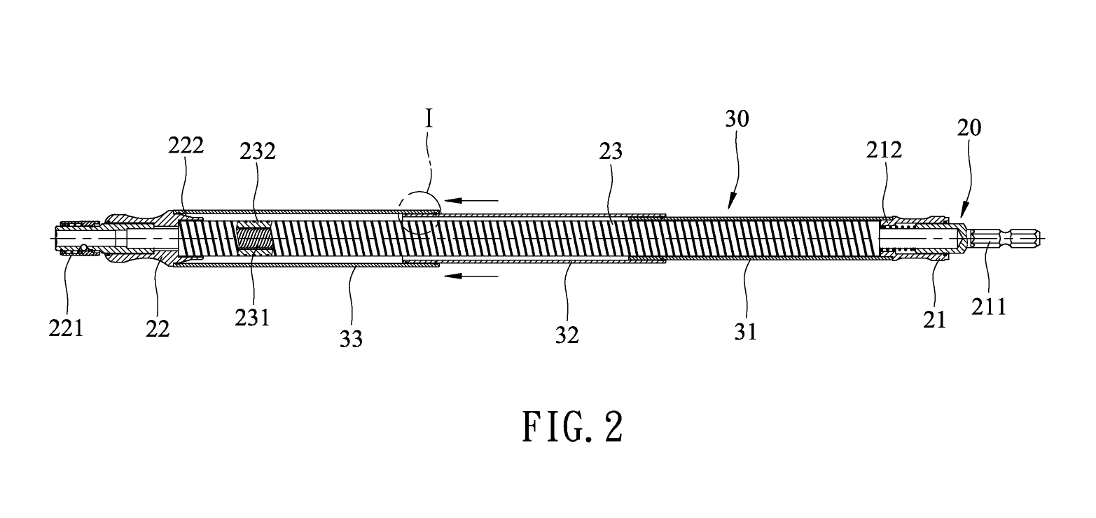

Referring to FIG. 2, a flexible tool rod device according to the first preferred embodiment of this invention includes an inner rod unit 20 and a sleeve pipe unit 30.

The inner rod unit 20 includes a drive head 21, a tool head 22 opposite to the drive head 21, and a flexible connecting member 23 interconnecting the drive and tool heads 21, 22. The drive head 21 is hollow and is engaged with a connecting rod 211 that is driven rotatably by a power source (not shown) such as a motor for driving rotation of the drive head 21. The tool head 22 has a holder 221 for holding a tool, such as a screw driver. The connecting member 23 is composed of a central cable 231 and a bellows tube 232 sleeved on the central cable 231. In this embodiment, the drive head 21 further has a securing portion 212 opposite to the connecting rod 211, and the tool head 22 further has an engaging portion 222 opposite to the holder 221. The connecting member 23 has two ends respectively riveted to the securing portion 212 of the drive head 21 and the engaging portion 222 of the tool head 22, so that rotation of the drive head 21 drives the tool head 22 to rotate via the connecting member 23.

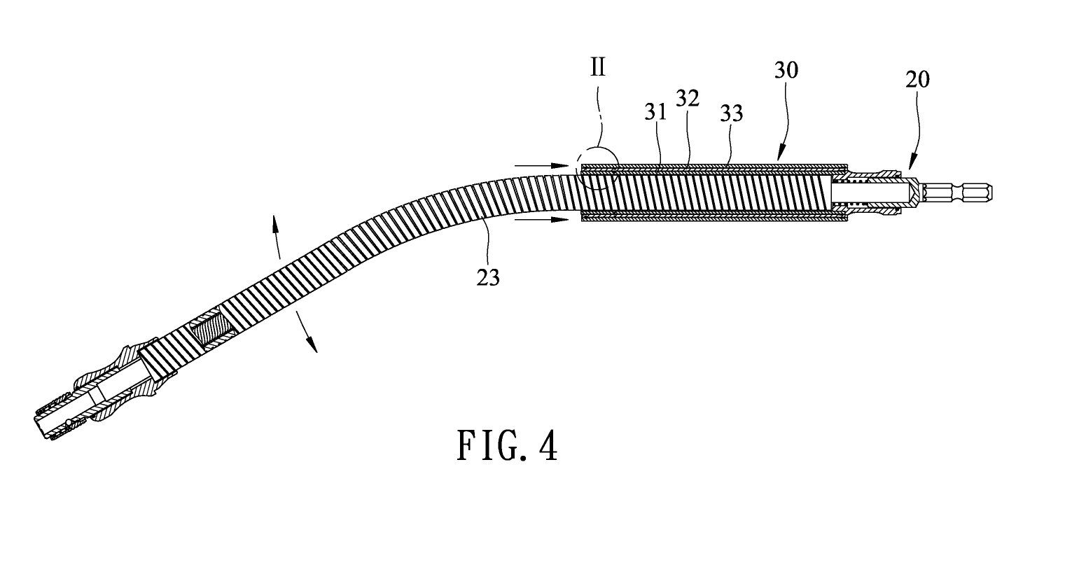

In this embodiment, the sleeve pipe unit 30 is made of rigid material and includes a first sleeve pipe 31, a second sleeve pipe 33 and a third sleeve pipe 32. The first sleeve pipe 31 has a first end portion that is riveted to the securing portion 212 of the drive head 21. The third sleeve pipe 32 is telescopically connected to the first sleeve pipe 31. The second sleeve pipe 33 is connected telescopically to the third sleeve pipe 32 (i.e., the third sleeve pipe 32 interconnects the first and second sleeve pipes 31, 33), and is movable relative to the first sleeve pipe 31 between a covered position (see FIG. 2), where the second sleeve pipe 33 is sleeved on the engaging portion 222 of the tool head 22 and cooperates with the third and first sleeve pipes 32, 31 to be sleeved on the connecting member 23 for providing rigidity to the flexible tool rod device, and an uncovered position (see FIG. 4), where the second sleeve pipe 33 is separated from the tool head 22 to expose a portion of the connecting member 23 so as to allow resilient deformation of the connecting member 23.

The first sleeve pipe 31 has an outer diameter slightly smaller than an inner diameter of the third sleeve pipe 32. The third sleeve pipe 32 has an outer diameter slightly smaller than an inner diameter of the second sleeve pipe 33. The first sleeve pipe 31 has a second end portion opposite to the first end portion of the first sleeve pipe 31. The third sleeve pipe 32 has a first end portion surrounding the second end portion of the first sleeve pipe 31 when the second sleeve pipe 33 is at the covered position, and a second end portion opposite to the first end portion thereof. The second sleeve pipe 33 has opposite first and second end portions. When the second sleeve pipe 33 is at the covered position, the first end portion thereof surrounds the second end portion of the second sleeve pipe 32, and the second end portion thereof is sleeved on the engaging portion 222 of the tool head 22.

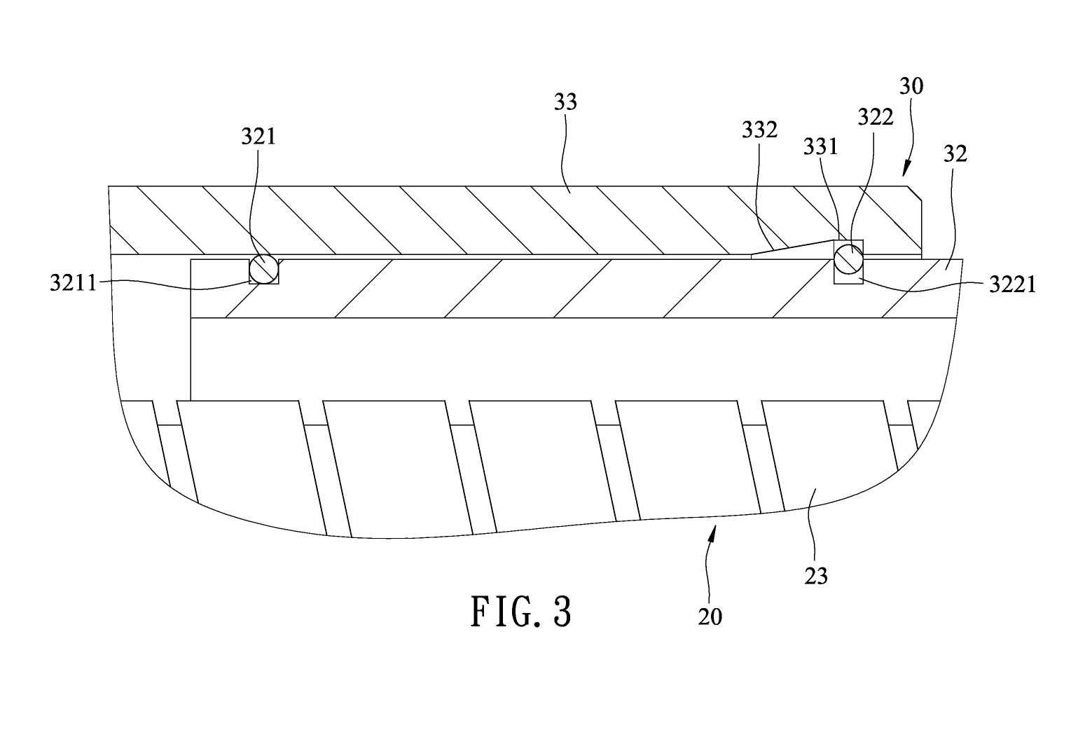

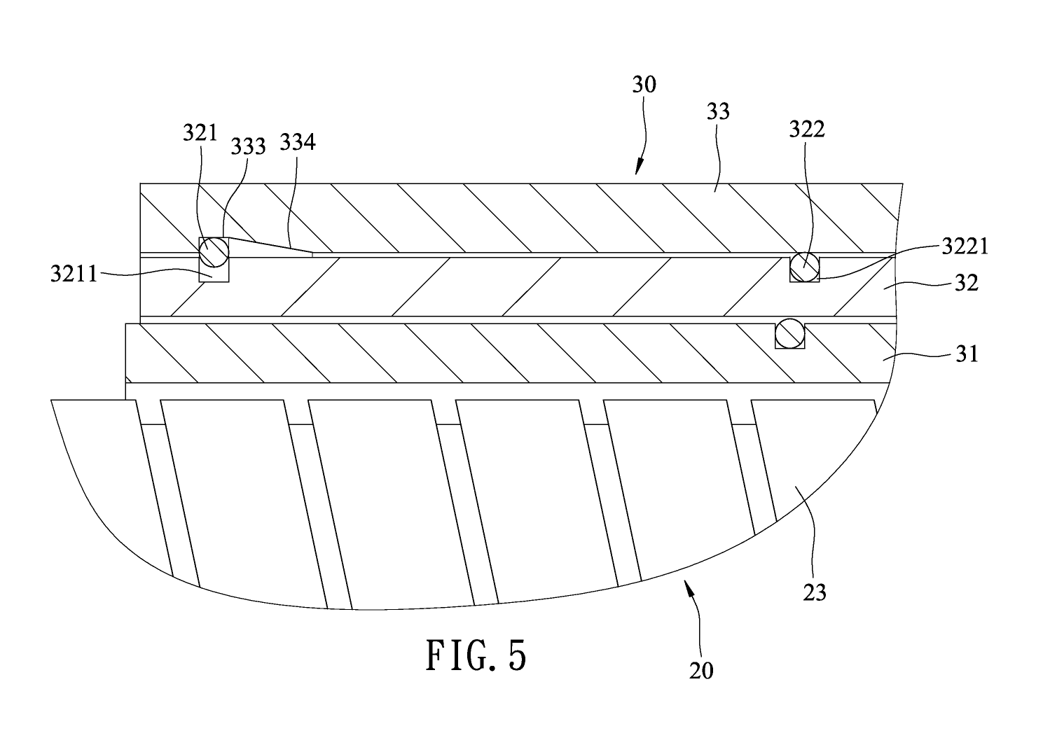

Referring to FIGS. 3 and 5, the second sleeve pipe 33 has an inner surrounding surface formed with a first annular groove 331 at the first end portion of the second sleeve pipe 33, and a second annular groove 333 at the second end portion of the second sleeve pipe 33. In this embodiment, the first annular groove 331 has a tapering portion 332 that tapers in a direction away from the first end portion of the second sleeve pipe 33, and the second annular groove 333 has a tapering portion 334 that tapers in an opposite direction away from the second end portion of the second sleeve pipe 33. The third sleeve pipe 32 has an outer surrounding surface that is formed with spaced-apart receiving grooves 3211, 3221 at the second end portion of the third sleeve pipe 32, and is provided with first and second elastic engaging rings 322, 321 received respectively in the receiving grooves 3221, 3211.

Similarly, a structure consisting of an elastic engaging ring and an engaging groove is provided between the third sleeve pipe 32 and the first sleeve pipe 31 for positioning the third sleeve pipe 32 relative to the first sleeve pipe 31 when the second sleeve pipe 33 is at the covered position.

Referring to FIG. 3, and further referring back to FIG. 2, when the second sleeve pipe 33 is moved from the uncovered position to the covered position, the connecting member 23 is completely covered by the sleeve pipe unit 30. The first elastic engaging ring 322 engages the first annular groove 331 of the second sleeve pipe 33 so as to position the second sleeve pipe 33 relative to the third sleeve pipe 32 and to prevent separation of the second sleeve pipe 33 from the third sleeve pipe 32. The tapering portion 332 of the first annular groove 331 facilitates the engagement between the first elastic engaging ring 322 and the first annular groove 331. The sleeve pipe unit 30 enhances rigidity of the flexible tool rod device of the present invention and stably transmits kinetic power from the drive head 21 to the tool head 22.

As shown in FIGS. 4 and 5, when the second sleeve pipe 33 is moved from the covered position to the uncovered position, the first elastic engaging ring 322 is disengaged from the first annular groove 331 (see FIG. 3) and is pressed inwardly by the inner surrounding surface of the second sleeve pipe 33 to be retained in the receiving groove 3221, while the second elastic engaging ring 321 engages the s second annular groove 333 to position the third sleeve pipe 32 relative to the second sleeve pipe 33. Similarly, the tapering portion 334 facilitates the engagement between the second elastic engaging ring 321 and the second annular groove 333. At this time, the connecting member 23 is partially exposed from the sleeve pipe unit 30 and deformation thereof is permitted.

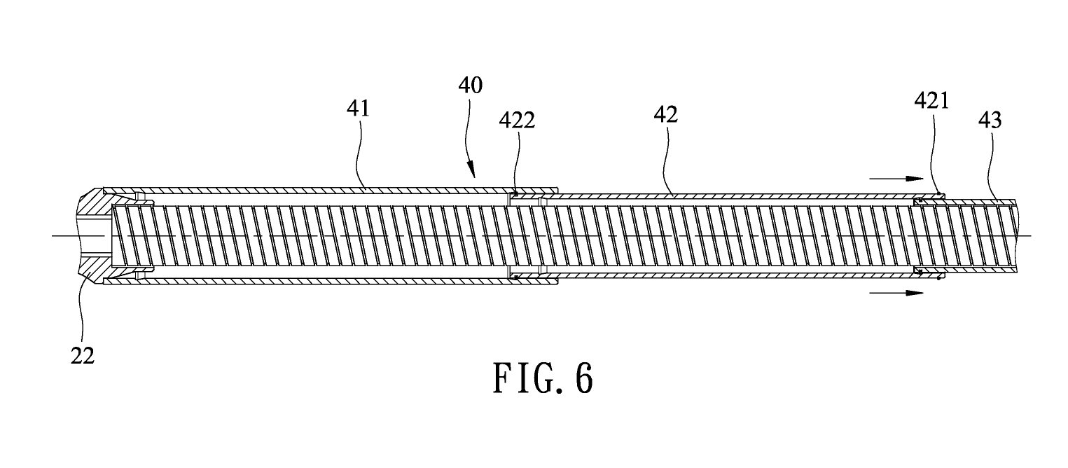

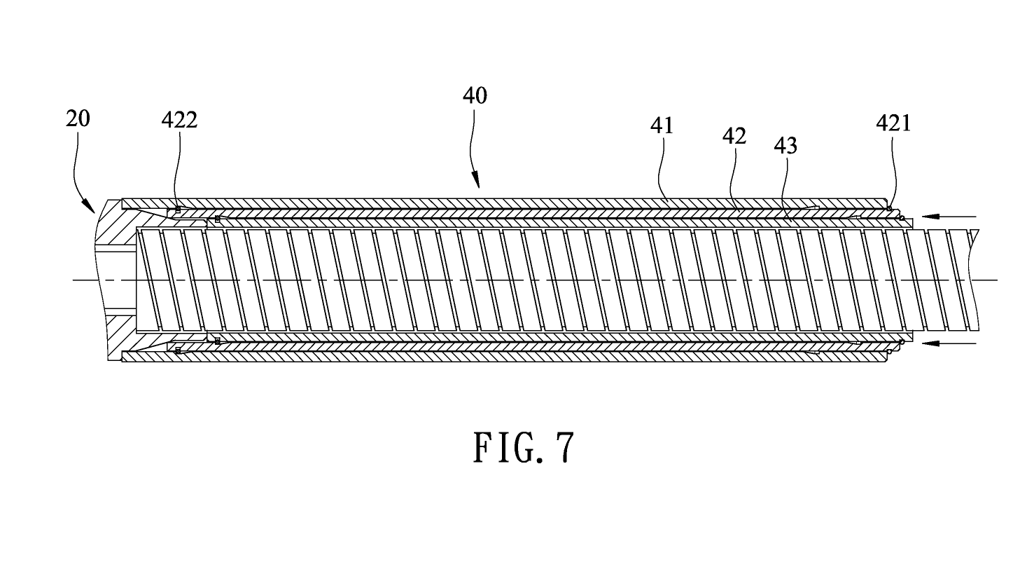

Referring to FIGS. 6, a second preferred embodiment of the flexible tool rod device according to the present invention has a structure similar to that of the first preferred embodiment. The main difference between this embodiment and the first preferred embodiment resides in the following. In this embodiment, the sleeve pipe unit 40 includes a first sleeve pipe 41 connected fixedly to the tool head 22, and second and third sleeve pipes 43, 42 telescopically connected to the first sleeve pipe 41. The third sleeve pipe 42 has an outer diameter slightly greater than an inner diameter of the first sleeve pipe 41 and an inner diameter smaller than an outer diameter of the second sleeve pipe 43. The second sleeve pipe 43 is movable between the covered position (see FIG. 6) and the uncovered position (see FIG. 7).

The third sleeve pipe 42 is provided with first and second elastic engaging rings 421, 422. When the second sleeve pipe 43 is at the covered position, as shown in FIG. 6, the first elastic engaging ring 421 is distal from the first sleeve pipe 41 and the second elastic engaging ring 422 engages an annular groove of the first sleeve pipe 41. When the second sleeve pipe 43 is pulled by a user to the uncovered position, as shown in FIG. 7, the second elastic engaging ring 422 engages another annular groove of the first sleeve pipe 41 while the first elastic engaging ring 421 abuts against an end of the first sleeve pipe 41 to prevent the third sleeve pipe 42 from being entirely retracted within the first sleeve pipe 41. The structural connection between the second and third sleeve pipes 43, 42 is identical to that between the first and third sleeve pipes 41, 42, so that the user can easily access the second sleeve pipe 43 during the next operation of the sleeve pipe unit 40.

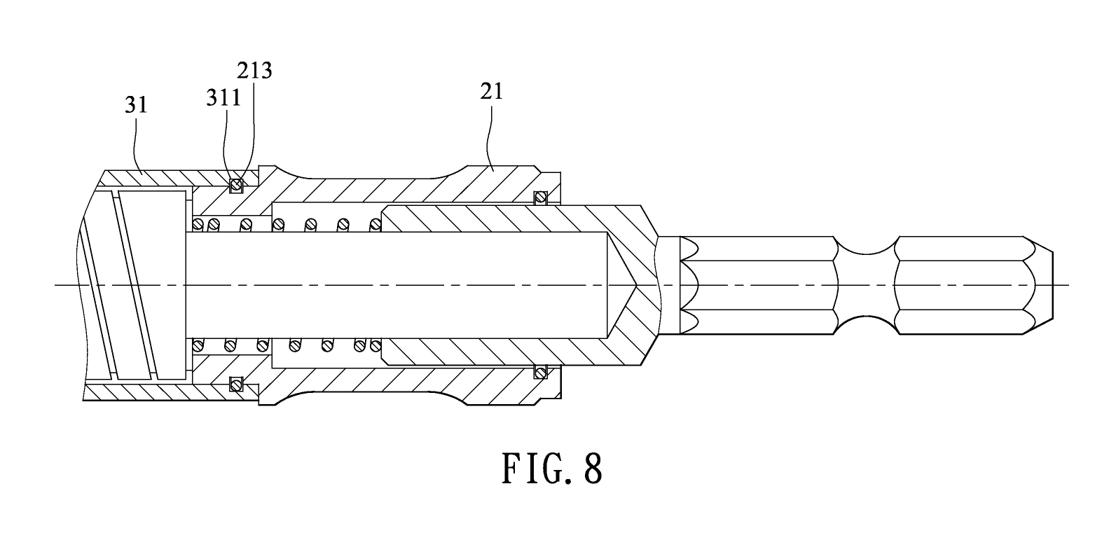

Referring to FIG. 8, a third preferred embodiment of the flexible tool device according to this invention has a structure similar to that of the first preferred embodiment except for the way the first sleeve pipe 31 is fixed to the drive head 21. In this embodiment, the first sleeve pipe 31 further has a third annular groove 311, and the drive head 21 is further formed with a drive elastic engaging ring 213 that engages fixedly the third annular groove 311 of the first sleeve pipe 31 to connect fixedly the first sleeve pipe 31 to the drive head 21.

It is noted that the third sleeve pipe 32 may be omitted in other embodiments of the invention.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A flexible tool rod device, comprising:
an inner rod unit that includes a drive head, a tool head opposite to said drive head, and a flexible connecting member interconnecting said drive and tool heads; and
a sleeve pipe unit that is made of a rigid material and that includes
a first sleeve pipe having a first end portion connected fixedly to one of said drive head and said tool head, and
a second sleeve pipe telescopically connected to said first sleeve pipe and movable relative to said first sleeve pipe between a covered position, where said second sleeve pipe is connected to the other one of said drive head and said tool head and cooperates with said first sleeve pipe to be sleeved on said connecting member for providing rigidity to said flexible tool rod device, and an uncovered position, where said second sleeve pipe is separated from the other one of said drive head and said tool head to expose a portion of said connecting member so as to allow resilient deformation of said connecting member.

2. The flexible tool rod device of claim 1, wherein said first end portion of said first sleeve pipe is connected fixedly to said drive head.

3. The flexible tool rod device of claim 1, wherein said first end portion of said first sleeve pipe is connected fixedly to said tool head.

4. The flexible tool rod device of claim 1, wherein:
said first sleeve pipe has an outer diameter slightly smaller than an inner diameter of said second sleeve pipe;
said first sleeve pipe has a second end portion opposite to said first end portion and surrounded by an end portion of said second sleeve pipe when said second sleeve pipe is at the covered position;
said second sleeve pipe has in inner surrounding surface formed with an annular groove at said end portion; and
said first sleeve pipe has an outer surrounding surface provided with an elastic engaging ring that is disposed at said second end portion and that engages said annular groove of said second sleeve pipe when said second sleeve pipe is at the covered position.

5. The flexible tool rod device as claimed in claim 4, wherein said annular groove of said second sleeve pipe has a tapering portion that tapers in a direction away from said end portion of said second sleeve pipe.
